(19) United States
(12) Patent Application Publication
(10) Pub. No.: US 2008/0071870 A1
(43) Pub. Date: Mar. 20, 2008

(54) Method and System for Implementing Online Help by Instant Messaging

(76) Inventor: Weibiao Zhan, Guangdong P.R. (CN)

Correspondence Address: LADAS & PARRY LLP, 224 SOUTH MICHIGAN AVENUE, SUITE 1600, CHICAGO, IL, 60604, US

(21) Appl. No.: 11/629,635

(22) PCT Filed: Jun. 17, 2005
(86) PCT No.: PCT/CN05/00875

§ 371 Date: May 7, 2007

(30) Foreign Application Priority Data
Jun. 18, 2004 (CN) 200410027736.4

(51) Int. Cl. G06F 15/16

(52) U.S. Cl. 709/206

(57) ABSTRACT

A method for implementing online help by instant messaging, including: instant messaging client software built in software of the user computer logging on an instant messaging server; sending a help request by instant messages from a user computer, and providing by a help information provider and an instant messaging server an instant help to the user computer according to the help request. A system for implementing online help by instant messaging, including: an instant messaging server, a user computer and a help information provider; the help information provider is connected to the instant messaging server, and the user computer logs on and connects to the instant messaging server using the instant messaging client software built in the software of the user computer; the instant messaging server and the help information provider provides the help service to the user computer by instant messaging.

### FIELD OF THE INVENTION

The present invention relates to the computer application technology, and in particular, to a method and a system for implementing online help by instant messaging.

### BACKGROUND OF THE INVENTION

At present, along with the computers being applied more and more widely, various computer application softwares are used more and more frequently. The functions of the software are usually designed to be relatively complicated to satisfy the requirements of various applications in the relevant field. However, it is not easy for the software users to know various functions of the software exactly in a short time. Thus, when using the software, a user may not know how to use the desired functions. In addition, misoperation may leads to errors in the working of the software and the software user may have no knowledge for solving these errors. In view of the above, existing software generally provides help functions to help users solve the above problems which may occur while the software is being used.

In the prior art, help information is generally attached in software and installed to a computer together with the software as the software being installed. When a problem occurs while the software is being used by a user, the user may search and call the help information in local computer, and the searched help information may be displayed in text or by software robot so as to provide help for the user.

The help information is attached in software and installed to a local computer together with the software, therefore, the help information only can provide help with respect to the problems which can be foreseen within a period of time. In the case of software upgrading or new problems emerging along with the applications, help information is hard to be updated to adapt to the changes of actual situations, which makes the help information relatively outdated. Because help information can not be provided in accordance with the changed situations, the Quality of Service (QoS) of the software help service is reduced.

Software is usually designed to be complicated and is able to provide various functions; however, the user may find no corresponding existent help information during the procedure of searching help information because of such reasons as that the selected keyword is unsuitable. In addition, some primary computer users may not be skilled in the help information searching, which makes the help information unable to function as it can be in a certain sense. In this case, if a humanized communion way is rendered to provide help information, the application efficiency of help information would be greatly improved, thus the QoS of software help service can be improved as well. In the prior art, however, the help information can be only provided by searching in the local stored help information, it is impossible to provide help information in a humanized communion way, thereby the QoS of the help service is affected.

### SUMMARY OF THE INVENTION

The embodiments of the present invention provide a method and a system for implementing online help by instant messaging, which can update help information in real time and provide help information in a humanized communion way via instant messaging.

A method for implementing online help by instant messaging, including:

instant messaging client software built in a software of a user computer logging on an instant messaging server;

sending a help request by instant messages from the user computer;

providing, by a help information provider and the instant messaging server, an instant help to the user computer according to the help request.

The step of logging on the instant messaging server includes:

logging on the instant messaging server according to an address of the instant messaging server stored in the instant messaging client software;

verifying, by the instant messaging server, identifier of the user computer logged on, if the verification is passed, performing the step of sending the help request by instant messages.

The step of sending the help request by instant messages includes:

sending, by the user computer, a help information interrogating instruction to the instant messaging server;

the step of providing by the help information provider and the instant messaging server the instant help to the user computer according to the help request includes:

searching, by the instant messaging server, in the help information acquired from the help information provider, returning the help information found to the user computer to display.

Preferably, the method further includes:

before the step of searching by the instant messaging server in the help information acquired from the help information provider,

uploading, by the help information provider, the help information stored in the help information provider to the instant messaging server by instant messaging;

saving, by the instant messaging server the help information.

Preferably, the method further includes:

updating, by the help information provider, the help information stored in it;

sending the help information by instant messaging to the instant messaging server;

saving, by the instant messaging server the help information.

The step of sending by the user computer the help information interrogating instruction to the instant messaging server includes:

generating, by the user computer, the help information interrogating instruction according to an input searching operation;

sending the help information interrogating instruction to the instant messaging server.

The step of sending by the user computer the help information interrogating instruction to the instant messaging server includes:

generating the help information interrogating instruction by performing operations according to preset prompts associated with the corresponding help in the user computer, and sending the help information interrogating instruction to the instant messaging server.

The step of sending the help request by instant messages includes:

sending, by the user computer, help-needed contents to the help information provider via the instant messaging server by instant messaging;

the step of providing by the help information provider and the instant messaging server the instant help to the user computer according to the help request includes:

returning, by the help information provider, via the instant messaging server by instant messaging, a real-time help solution given by technical staff according to the help-needed contents to the user computer to display.

The step of sending by the user computer the help request by instant messaging and providing by the help information provider and the instant messaging server the instant help to the user computer according to the help request includes at least one of automatic answering processes and humanized communication processes,

the automatic answering processes includes:

sending, by the user computer, a help information interrogating instruction to the instant messaging server;

searching, by the instant messaging server, in the help information acquired from the help information provider according to the interrogating instruction;

returning, by the instant messaging server, the help information found to the user computer to display;

the humanized communication processes includes:

sending, by the user computer, help-needed contents to the help information provider via the instant messaging server by instant messaging;

returning, by the help information provider, via the instant messaging server by instant messaging, a real-time help solution given by technical staff according to the help-needed contents to the user computer to display.

Preferably, the method further includes:

before sending the help request and providing the instant help to the user computer according to the help request,

selecting either of the automatic answering or the humanized communication processes; and

performing the processes selected, deciding whether the help service is implemented by the processes selected, if the help service is not implemented, selecting and performing the other processes unselected.

Preferably, the method further includes:

sending, by the user computer, via the instant messaging server, a help information updating request to the help information provider,

updating, by the help information provider, the help information according to the help information updating request.

The help information provider may be a customer service provider of software manufacturer.

A system for implementing online help by instant messaging, including: an instant messaging server, a user computer and a help information provider, wherein

the help information provider connects to the instant messaging server;

the user computer logs on and connects to the instant messaging server via instant messaging client software built in the software of the user computer;

the instant messaging server and the help information provider provides a help service to the user computer by instant messaging.

The help information provider stores and updates help information, and uploads the help information to the instant messaging server;

the instant messaging server stores the help information uploaded by the help information provider, interrogates and obtains help contents from the help information according to a help information interrogating instruction sent by the user computer, and provides the help contents to the user computer by instant messaging;

the user computer logs on the instant messaging server according to the instant messaging client software built in the software of the user computer and sends the help information interrogating instruction to the instant messaging server, acquires and displays the help contents returned by the instant messaging server.

The user computer logs on the instant messaging server according to the instant messaging client software built in the software and sends help-needed contents, receives and displays a real-time help solution given by technical staff of the help information provider;

the instant messaging server sends the help-needed contents from the user computer to the help information provider by instant messaging, and sends the real-time help solution given by the technical staff of the help information provider to the user computer;

the help information provider receives the help-needed contents and sends the real-time help solution given by the technical staff of the help information provider.

The help information provider stores and updates help information and uploads the help information to the instant messaging server, and receives help-needed contents and sends a real-time help solution given by technical staff of the help information provider;

the instant messaging server stores the help information uploaded by the help information provider, interrogates and acquires help contents from the help information according to a help information interrogating instruction sent by the user computer, and provides the help contents to the user computer by instant messaging; sends the help-needed contents by the user computer to the help information provider by instant messaging, and sends the real-time help solution given by the technical staff of the help information provider to the user computer;

the user computer logs on the instant messaging server according to the instant messaging client software built in the software of the user computer, sends the help information interrogating instruction to the instant messaging server, and acquires and displays the help contents returned by the instant messaging server; sends the help-needed contents, and receives and displays the real-time help solution given by the technical staff of the help information provider.

The help information provider may be a customer service provider of software manufacturer.

It can be seen that the help information can be updated in time by the method and system provided by embodiments of the present invention so that the user can always acquire the up-to-date help information; in addition, the embodiment of the present invention further provides the help information in a humanized way, so that those people for whom it is undesirable or difficult to acquire instant help in searching way can acquire the help information conveniently, thus the QoS of help service is improved greatly.

### BRIEF DESCRIPTION OF THE DRAWINGS

FIG. 1 shows a schematic diagram of the system provided by an embodiment of the present invention.

FIG. 2 is a flow chart of the method according to an embodiment of the present invention.

### DETAILED DESCRIPTION OF THE INVENTION

The embodiments of the present invention provide a method and a system for implementing online help by instant messaging. In an embodiment, an instant messaging server is preset, and the instant messaging server is connected to a help information provider; meanwhile, instant messaging client software is built in software of the user computer. Once a problem occurs while the software is being used, a user can log on the instant messaging server by calling the instant messaging client software built in the software of the user computer, and can acquire, via the instant messaging server, the up-to-date help information from the help information provider by instant messaging. In actual applications, the help information in the help information provider can be updated in accordance with the changes of situations and the updated help information can be provided to the user, so that the user can always acquire the up-to-date help information; if a user is disinclined to acquire help information by searching, he may solve problems via real-time communication with technical staff of the help information provider via the instant messaging server, so that the help information can be obtained in a humanized way and the QoS of help service can be improved.

The embodiments of the present invention are hereinafter described in detail with reference to the attached drawings. In the embodiments hereinafter, a customer service provider of software manufacturer serves as the help information provider to provide help information. In other embodiments of the present invention, a content provider can also be used as a help information provider, which will not affect the implementation of the present invention.

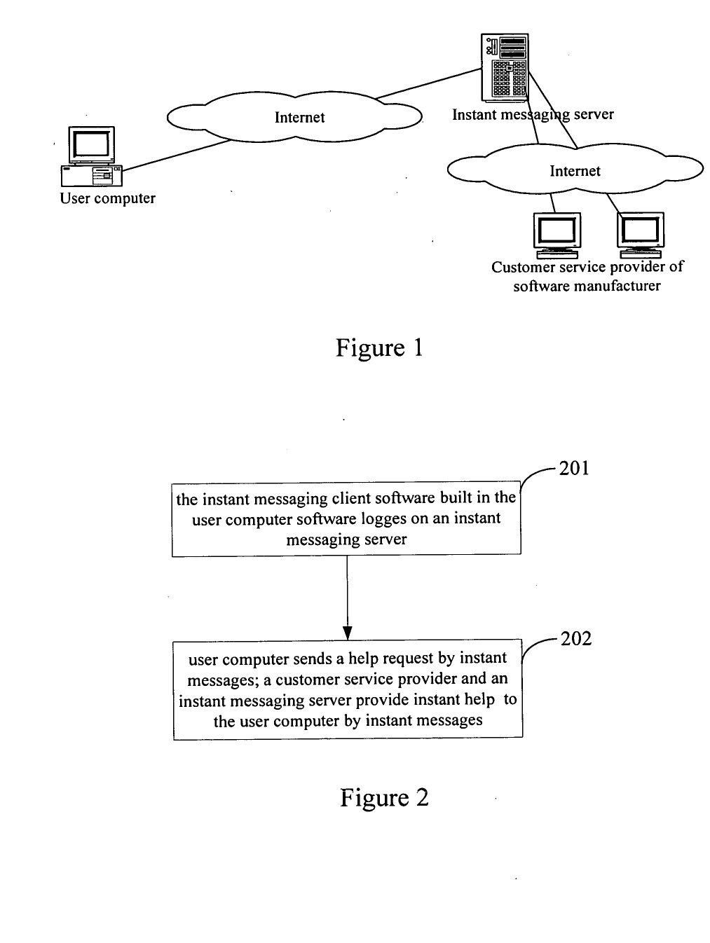

Refer to FIG. 1, the system provided in an embodiment includes an instant messaging server, a user computer and a customer service provider of software manufacturer which is called a customer service provider for short hereinafter, and the customer service provider is connected to the instant messaging server, the user computer logs on and connects to the instant messaging server by using the instant messaging client software built in the software of the user computer; the instant messaging server and the customer service provider provides the help to the user computer by instant messaging, i.e., by instant messages.

A detailed description of the system in accordance with the embodiments will be given hereinafter.

### EMBODIMENT 1

In this embodiment, a customer service provider provides help information to the user by instant messaging in an automatic answering way.

The customer service provider is configured for storing and updating help information, and uploading the currently stored help information to an instant messaging server.

The instant messaging server is used for storing the help information uploaded by the customer service provider, searching the corresponding help contents according to a help information interrogating instruction sent by the user computer, and providing the help contents to the user computer by instant messaging.

The user computer is used for logging on the instant messaging server using the instant messaging client software built in the software of the user computer and sending a help information interrogating instruction to the instant messaging server, acquiring and displaying the found contents returned by the instant messaging server.

In this embodiment, the help information interrogating instruction can be sent by inputting searching keywords on the user computer or sent by performing operations according to preset prompts associated with the corresponding help in the user computer, and alternatively, the instruction may be sent in other ways, which will not affect the implementation of the present invention.

### EMBODIMENT 2

In this embodiment, a customer service provider provides help information to the user by instant messaging in a humanized communion way.

The user computer is for use in logging on the instant messaging server using the instant messaging client software built in the software of the user computer; sending help-needed contents; receiving and displaying the real-time help solution given by the technical staff of customer service provider.

The instant messaging server is for use in conducting the instant messaging between the user computer and the customer service provider, i.e. sending the help-needed contents from the user computer to the customer service provider by instant messaging, and, sending the real-time help solution given by the technical staff of customer service provider to the user computer.

The customer service provider is for use in receiving the help-needed contents and sending the real-time help solution given by the technical staff.

In this embodiment, the customer service provider need not store help information, which reduces the implementation difficulty in the customer service provider. In addition, the technical staff provides by instant messaging real-time solutions to various help requests sent by users via the customer service provider, so that the help provided is more pertinent, and especially, for the users for whom the help in the searching and prompting ways is difficult to use, more convenience service can be provided.

### EMBODIMENT 3

In Embodiments 1 and 2, the automatic answering way and the humanized communion way are used separately to provide help service to users. In order to provide help service to users more conveniently and comprehensively, in this embodiment, help service is provided to users by the combination of the above two ways.

The customer service provider is for use in storing and updating help information and uploading the currently stored help information to the instant messaging server; receiving the help-needed contents; sending the real-time help solution given by the technical staff.

The instant messaging server is for use in storing the help information uploaded by the customer service provider; searching and acquiring the corresponding contents in the help information according to the help information interrogating instruction sent by the user computer; providing the corresponding contents to the user computer by instant messaging; sending the help-needed contents from the user computer to the customer service provider by instant messaging; and sending the real-time help solution given by the technical staff of customer service provider to the user computer.

The user computer is for use in logging on the instant messaging server using the instant messaging client software built in the software of the user computer, sending a help information interrogating instruction to the instant messaging server; acquiring and displaying the found contents returned by the instant messaging server; sending the help-needed contents; receiving and displaying the real-time help solution given by the technical staff of customer service provider.

In this embodiment, the help service can be provided in a more flexible and comprehensive way, for example, the user may first request a help service in an automatic answering way; if the help information requested by the user can not be provided in this way, the help service can be executed in a humanized communication way so as to provide the help information requested by the user from the technical staff. In addition, the user can also optionally select a way to implement the help service according to personal habits, which will not affect the implementation of the present invention.

In the above embodiment, the user computer may be further used for sending help information updating request to the customer service provider via the instant messaging server, and the help information updating request includes the opinions and proposals of the users associated with the help service, and the customer service provider may be further used for updating the help information according to the received help information updating request.

The method provided by an embodiment of the present invention is hereinafter described in detail.

Refer to FIG. 2, the method provided by the embodiments of the present invention includes the steps of:

Step 201: the instant messaging client software built in the software of the user computer logging on an instant messaging server;

Step 202: the user computer sending a help request by instant messages, a customer service provider and an instant messaging server providing an instant help to the user computer by instant messages according to the help request.

More specific implementation of the above steps is hereinafter described with reference to specific examples:

1. The implementation of step 201:

In this embodiment, the address of the instant messaging server is stored in advance in the instant messaging client software built in the software of the user computer. When calling instant messaging client software, logging on the instant messaging server directly according to the address. The instant messaging server verifies the identifier of the user computer trying to log on. If the verification is passed, the subsequent step is performed, otherwise this procedure ends.

2 The implementation of Step 202:

The implementation of Step 202 is hereinafter described in detail according to the different ways of implementing help services, respectively.

(1) The help service is implemented in an automatic answering way. In this case, the implementation of step 202 includes the following steps.

Step a1: the user computer sends a help information interrogating instruction to the instant messaging server;

Step a2: the instant messaging server searching in the help information acquired from the customer service provider and returning the searched help information to the user computer to display.

During the implementation of this embodiment, the customer service provider uploads, by instant messaging, the help information stored by itself to the instant messaging server to store, and, sends, by instant messaging, the updated help information, in the case of help information being updated, to the instant messaging server to store.

During the implementation of this embodiment, the user computer can generate a help information interrogating instruction according to the input searching operation and sending the instruction to the instant messaging server, or generate a help information interrogating instruction by performing operations according to preset prompts associated with the corresponding help in the user computer, which will not affect the implementation of the present invention.

(2) The help service is implemented in a humanized communication way. In this case, the implementation of Step 202 includes the following steps.

Step b1: the user computer sending, by instant messaging, the help-needed contents to the customer service provider via the instant messaging server;

Step b2: the customer service provider returning, via the instant messaging server by instant messaging, the real-time help solution given by the technical staff according to help-needed contents to the user computer to display.

In another embodiment of the present invention, in order to provide help service to users more conveniently and comprehensively, an automatic answering way and/or a humanized communion way can be used to implement help service. In the case of implementing a help service via the automatic answering way, Step 202 can be implemented via the above Steps a1 and a2; in the case of implementing a help service via the humanized communication way, Step 202 can be implemented via the above Steps b1 and b2. Users may select either of the automatic answering way and the humanized communication way to implement a help service, or select one of the ways to implement a help service in the manner of:

selecting either of the automatic answering way and the humanized communication way to perform a help service, deciding whether the help service is implemented via the selected way, if the help service is implemented via the selected way, the procedure of the help service terminates, otherwise, selecting the other way to implement the help service.

In the embodiment, the user computer may further send, via the instant messaging server, to the customer service provider a help information updating request carrying the opinions and proposals of the user associated with the help service, and the customer service provider will update the help information according to the received help information updating request.

The foregoing are only preferred embodiments and are not for use in limiting this invention, any modification, equivalent replacement or improvement made under the spirit and principles of this invention is included in the protection scope of this invention.

1. A method for implementing online help by instant messaging, comprising:
instant messaging client software built in a software of a user computer logging on an instant messaging server;
sending a help request by instant messages from the user computer;
providing, by a help information provider and the instant messaging server, an instant help to the user computer according to the help request.

2. The method of claim 1, wherein the step of logging on the instant messaging server comprises:
logging on the instant messaging server according to an address of the instant messaging server stored in the instant messaging client software;
verifying, by the instant messaging server, identifier of the user computer logged on, if the verification is passed, performing the step of sending the help request by instant messages.

3. The method of claim 1, wherein the step of sending the help request by instant messages comprises:
sending, by the user computer, a help information interrogating instruction to the instant messaging server;
the step of providing by the help information provider and the instant messaging server the instant help to the user computer according to the help request comprises:
searching, by the instant messaging server, in the help information acquired from the help information provider, returning the help information found to the user computer to display.

4. The method of claim 3, further comprising:
before the step of searching by the instant messaging server in the help information acquired from the help information provider,
uploading, by the help information provider, the help information stored in the help information provider to the instant messaging server by instant messaging;
saving, by the instant messaging server the help information.

5. The method of claim 4, further comprising:
updating, by the help information provider, the help information stored in it;
sending the help information by instant messaging to the instant messaging server;
saving, by the instant messaging server the help information.

6. The method of claim 3, wherein the step of sending by the user computer the help information interrogating instruction to the instant messaging server comprises:
generating, by the user computer, the help information interrogating instruction according to an input searching operation;
sending the help information interrogating instruction to the instant messaging server.

7. The method of claim 3, wherein the step of sending by the user computer the help information interrogating instruction to the instant messaging server comprises:
generating the help information interrogating instruction by performing operations according to preset prompts associated with the corresponding help in the user computer, and sending the help information interrogating instruction to the instant messaging server.

8. The method of claim 1, wherein the step of sending the help request by instant messages comprises:

9. The method of claim 1, wherein the step of sending by the user computer the help request by instant messaging and providing by the help information provider and the instant messaging server the instant help to the user computer according to the help request comprises at least one of automatic answering processes and humanized communication processes,
the automatic answering processes comprises:
sending, by the user computer, a help information interrogating instruction to the instant messaging server;
searching, by the instant messaging server, in the help information acquired from the help information provider according to the interrogating instruction;
returning, by the instant messaging server, the help information found to the user computer to display;
the humanized communication processes comprises:
sending, by the user computer, help-needed contents to the help information provider via the instant messaging server by instant messaging;
returning, by the help information provider, via the instant messaging server by instant messaging, a real-time help solution given by technical staff according to the help-needed contents to the user computer to display.

10. The method of claim 9, further comprising:
before sending the help request and providing the instant help to the user computer according to the help request,
selecting either of the automatic answering or the humanized communication processes; and
performing the processes selected, deciding whether the help service is implemented by the processes selected, if the help service is not implemented, selecting and performing the other processes unselected.

11. The method of claim 1, further comprising:
sending, by the user computer, via the instant messaging server, a help information updating request to the help information provider,
updating, by the help information provider, the help information according to the help information updating request.

12. The method of claim 11, wherein the help information provider comprises a customer service provider of software manufacturer.

13. A system for implementing online help by instant messaging, comprising: an instant messaging server, a user computer and a help information provider, wherein
the help information provider connects to the instant messaging server, and
the user computer logs on and connects to the instant messaging server via instant messaging client software built in software of the user computer;
the instant messaging server and the help information provider provide a help service to the user computer by instant messaging.

14. The system of claim 13, wherein
the help information provider stores and updates help information, and uploads the help information to the instant messaging server;
the instant messaging server stores the help information uploaded by the help information provider, interrogates and obtains help contents from the help information according to a help information interrogating instruction sent by the user computer, and provides the help contents to the user computer by instant messaging;
the user computer logs on the instant messaging server according to the instant messaging client software built in the software of the user computer and sends the help information interrogating instruction to the instant messaging server, acquires and displays the help contents returned by the instant messaging server.

15. The system of claim 13, wherein
the user computer logs on the instant messaging server according to the instant messaging client software built in the software and sends help-needed contents, receives and displays a real-time help solution given by technical staff of the help information provider;
the instant messaging server sends the help-needed contents from the user computer to the help information provider by instant messaging, and sends the real-time help solution given by the technical staff of the help information provider to the user computer;
the help information provider receives the help-needed contents and sends the real-time help solution given by the technical staff of the help information provider.

16. The system of claim 13, wherein
the help information provider stores and updates help information and uploads the help information to the instant messaging server, and receives help-needed contents and sends a real-time help solution given by technical staff of the help information provider;
the instant messaging server stores the help information uploaded by the help information provider, interrogates and acquires help contents from the help information according to a help information interrogating instruction sent by the user computer, and provides the help contents to the user computer by instant messaging; sends the help-needed contents by the user computer to the help information provider by instant messaging, and sends the real-time help solution given by the technical staff of the help information provider to the user computer;
the user computer logs on the instant messaging server according to the instant messaging client software built in the software of the user computer, sends the help information interrogating instruction to the instant messaging server, and acquires and displays the help contents returned by the instant messaging server; sends the help-needed contents, and receives and displays the real-time help solution given by the technical staff of the help information provider.

17. The system of claim 13, wherein the help information provider comprises a customer service provider of software manufacturer.
